(19) United States
(12) Patent Application Publication
(10) Pub. No.: US 2005/0155500 A1
(43) Pub. Date: Jul. 21, 2005

(54) Screen printing and laser treating system and method

(75) Inventors: George P. Latos, Trabuco Canyon, CA (US); Wayne K. Shaffer, Penfield, NY (US)

Correspondence Address: Stephen B. Salai, Esq.;Harter, Secrest & Emery LLP, 1600 Bausch & Lomb Place, Rochester, NY, 14604-2711, US

(73) Assignee: Icon Textile Laser Systems, Inc., Vernon, CA (US)

(21) Appl. No.: 10/759,476

(22) Filed: Jan. 16, 2004

(51) Int. Cl. B41M 1/12; B41F 15/12

(52) U.S. Cl. 101/126; 101/129

(57) ABSTRACT

A marking apparatus for printing and laser treating a workpiece in a single registration with a pallet. Printing heads and pallets are moveable relative to each other to apply an ink to the workpiece, such that, upon locating the printing head in relocated position, a laser beam can controllably intersect the workpiece.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention p The present invention relates to the marking of workpieces including fabrics, garments or textiles and, more particularly, to the application of an ink and laser treatment of a workpiece, wherein the ink can be applied by screen printing and the laser treatment can be performed on a workpiece with a single registration of the workpiece relative to a pallet.

2. Background Art

Screen printing has grown over the past several decades into a high volume business. A large segment of this industry requires the printing of numerals upon athletic shirts and jerseys for high school, college, professional and amateur athletic teams as well as for casual wear sport jerseys and T-shirts.

Screening technology includes locating a transmissible screen adjacent the garment, wherein predetermined portions of the screen are occluded to preclude the passage of ink, such that, upon urging ink against the screen, the ink passes the selected regions of the screen to color the underlying garment.

Multiple screens can be used to create the desired image on the workpiece. Therefore, the screens and associated frames must be accurately located when mounted on the printing apparatus to assure proper placement of the printed image onto the garment. The screen must be registered or positioned in lateral and longitudinal directions relative to a pallet and the material mounted thereon to assure quality of the printing process. When more than one color is employed, the precise registration or positioning becomes even more critical.

The need exists for a system that can provide screen printing of the workpiece, while also permitting alternative treatments, without interfering with the screen printing process. The need further exists for a system that can employ the registration of the workpiece with respect to a pallet from a screen printing process for additional or alternative treatments.

### BRIEF SUMMARY OF THE INVENTION

The present invention provides a marking apparatus for marking a workpiece with ink and laser treatment, while the workpiece is in a registered orientation with a pallet. In a further configuration, the apparatus provides for screen printing and laser marking, as well as laser treatment and cutting, on the workpiece, while the workpiece remains in a single predetermined registration with a pallet.

Generally, the marking apparatus includes a plurality of pallets and a plurality of printing heads, each of the printing heads moveable relative to the corresponding pallet between a printing position and a standby (non-printing) position.

The marking apparatus further includes a laser marker for projecting a laser beam along a projection path to intersect the pallet. The laser marker can employ any of variety of laser configurations including scanning or polygon lasers. The laser can be used to perform any of a variety of operations or treatments of the workpiece, including but not limited to scribing, fading, photo-decomposing of a dye or ink, cutting, perforating, abrading, marking, detailing, decorating, curing or ablating, wherein these processes can be employed to form any type of pattern, graphic or indicia to the workpiece (collectively referred to as treatment).

In one configuration, the intersection of the laser beam with the pallet is dependent upon the position of the pallet relative to the printing head. For example, intersection of the laser beam with the pallet may be precluded, when the printing head is in the printing position.

In further configurations, the pallet can be moveable relative to a plurality of fixed printing heads, wherein the pallet moves to be operably aligned with the laser.

The present marking apparatus thus provides a method for marking a workpiece such as a garment, textile or fabric by registering the workpiece relative to the pallet; treating the workpiece with a laser; applying ink to mark the workpiece while in registration with the pallet; and removing the laser treated and inked workpiece from the pallet. In selected configurations, the ink can be applied to the workpiece by passing the ink through a screen.

### BRIEF DESCRIPTION OF THE SEVERAL VIEWS OF THE DRAWING(S)

FIG. 1 is a perspective view of one configuration of the marking apparatus.

FIG. 2 is a top view of the marking apparatus.

FIG. 3 is a side elevated view of the marking apparatus.

FIG. 4 is a schematic view of the laser component.

FIG. 5 is an alternative configuration of the marking apparatus.

FIG. 6 is a further configuration of the marking apparatus.

FIG. 7 is yet another alternative configuration of the marking apparatus.

### DETAILED DESCRIPTION OF THE INVENTION

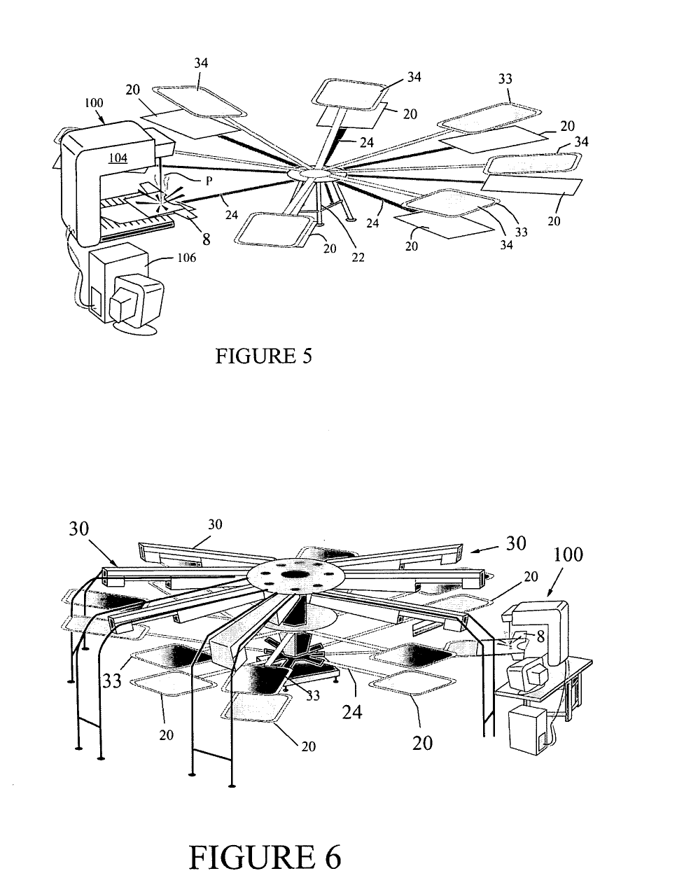

Generally, the present invention is set forth as a marking apparatus 10, wherein both ink (such as screen) printing and laser treating (as well as laser modification, laser cutting, laser indicia application, laser marking or laser heating) can be applied to a workpiece 8. As seen in FIGS. 5-7, the marking apparatus 10 includes a laser marker 100 and a printing head 30 for marking the workpiece on a pallet 20.

The workpiece 8 can be any of a variety of constructions including fabrics, textiles, garments, and garment components as well as media such as disks, displays, folders, webs, packaging and panels. A variety of materials can be processed as the workpiece 8 with the marking apparatus 10 including, but not limited to, fabrics, leathers, vinyls, synthetics, rubber, wood, metals, plastics, ceramics, glass, and other materials. These materials can be used to make a variety of different goods. Some common examples include clothing, linens, footwear, belts, purses and wallets, luggage, vehicle interiors, furniture coverings, and wall coverings.

The present marking apparatus 10 can be employed in a system having a single station or a plurality of stations or pallets 20. In the configuration employing a plurality of pallets 20, the pallets can be distributed in any of a variety of configurations including, but not limited to, carousel, processing lines and modular.

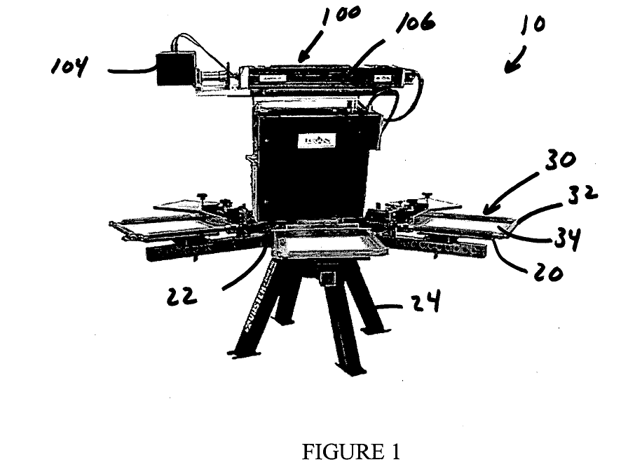

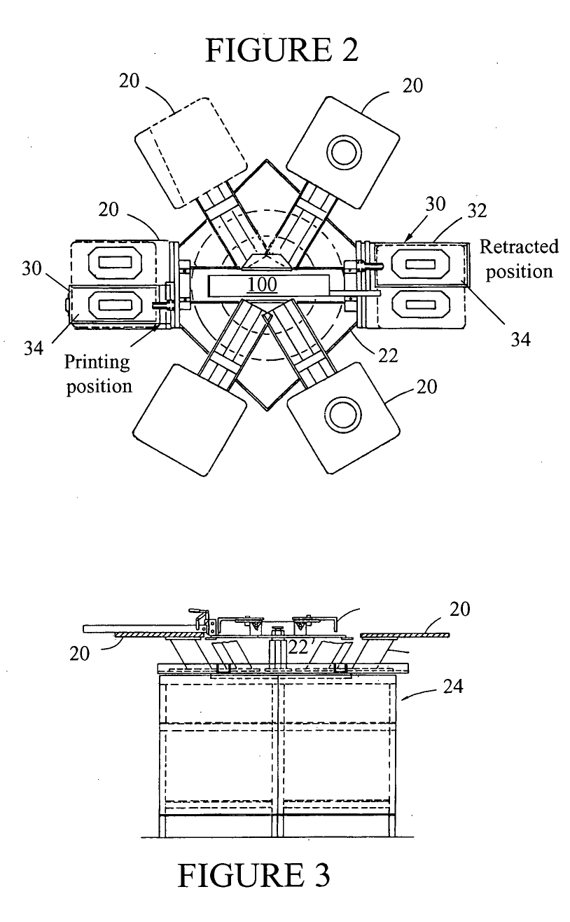

Exemplary versions of the multiple station marking apparatus 10 are shown in FIGS. 1-3 and 5-7. However, the present marking apparatus 10 is equally applicable to a single station, as well as single and multiple color printing devices.

For purposes of brevity, a six-pallet, two-color marking apparatus is shown and will be generally described only so far as necessary to understand the operation of the present invention in a context recognized by those skilled in the art. The seven pallet configurations of FIGS. 5-7 are set forth in terms sufficient to describe the present inventive aspects.

Referring to FIGS. 1 and 5-7, a rotatable indexing table 22 and associated supporting frame are shown. In the configuration of FIG. 1, six workpiece receiving pallets 20 are mounted on pallet supports 24 which in turn are mounted on the indexing table 22. Each pallet 20 is automatically indexed to rotate to each of the six operating stations for loading and unloading, printing, drying, laser treating, and the like in a sequenced manner about a central shaft. The control of the pallets can be coordinated with control of the laser marker 100. It is understood control of the laser marker 100 and printing can be integrated.

The registration of the workpiece 8 relative to the pallet 20 can be accomplished by any of a variety of mechanisms. For example, the workpiece 8 can include a fiducial or reference indicia, and the pallet 20 can include a corresponding seating or alignment surface. In such a configuration, upon aligning the reference indicia and the seating surface, the workpiece 8 is registered with the pallet 20. Alternatively, the workpiece can include a feature to be aligned with the pallet. Although a single registration of the workpiece relative to the pallet 20 is described, it is understood the workpiece and the pallet can have separate registrations for the printing and the laser treating steps.

Alternatively, the workpiece can be manually located and clamped or held in position on the pallet 20, prior to moving the printing head 30 to the printing position relative to the pallet.

As shown in FIGS. 1-3 and 5-7, the printing head 30 can include a frame 33 for retaining a screen 34, wherein the screen will bear the pattern to be inked on the workpiece 8. The printing head 30 either includes or cooperates with an ink supply and ink distributor, such as a blade or plough. At least the screen 34 can be moveably connected relative to the pallet 20 between a printing position and a (retracted) standby or non-printing position. In the printing position, the screen 34 is oriented relative to the pallet 20 in a predetermined and reproducible location, so as to allow ink passing through the screen to mark the workpiece in a predetermined manner. In the non-printing (retracted) position, the screen 34 is spaced from the pallet 20. Movement of the pallet 20 and/or the screen 34 between the printing position and the retracted (non-printing) position can be along of variety of paths such as pivoting, rotating, folding or sliding. The pallet 20 and/or screen 34 can be moved between the printing and the retracted position by any of a variety of mechanisms, including but not limited to hydraulic, pneumatic, gears, cams and bias mechanisms. The printing head 30 and the pallet 20 can be operably retained in the printing position by any of a number of mechanisms including, but not limited to, clasps, detents and pins, as well as servo or electromechanical couplers.

Alternatively, the screen 34 can be substantially fixed and the pallet 20 moved relative to the screen. It is understood the relative motion of the pallet 20 and the printing head 30 can be any of a variety of configurations, including fixed pallet—moving printing head; moving pallet—fixed printing head; and moving pallet—moving printing head, without impacting the scope of the present invention.

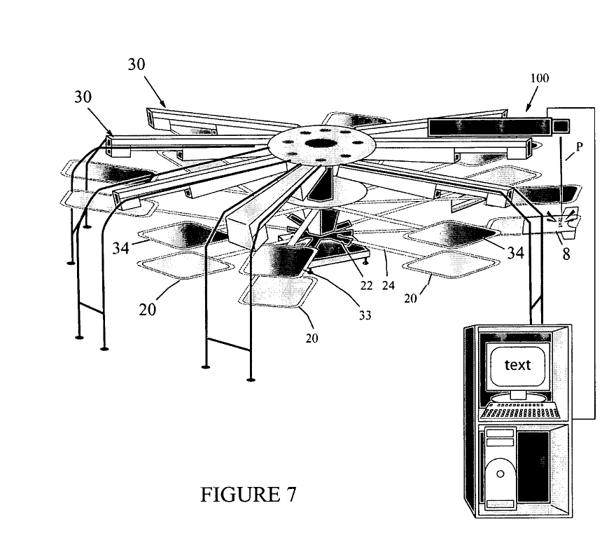

As seen in FIGS. 6 and 7, a portion of the printing head 30 is disposed above pallets 20. In one configuration, the pallet 20 and corresponding screen 34 move vertically to operably engage the remainder of the printing head 30. The portions of the printing head 30 located above the pallet 20 can include the squeegee, flood bar and ink supply (or connection to the ink supply).

For screen printing, the printing head 30 includes the frame 33 for retaining the screen 34, wherein the screen will bear the pattern to be inked. In this construction, the printing head 30 also either includes or cooperates with the ink supply and ink distributor, such as a blade, bar or plough.

Although the printing head 30 is set forth in terms of screen printing, it is understood that alternative printing heads can be employed, such as ink, ink jet, dot matrix printers, as well as laser printers, wherein the printing head is moveable relative to the pallet 20 between the printing position and the retracted (spaced, non-printing) position.

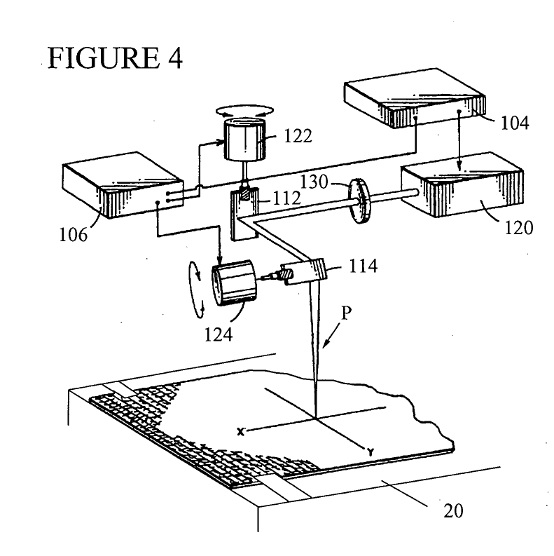

FIG. 4 is a schematic diagram of the laser marker 100. The laser maker 100 projects a laser beam along a projection path P to intersect the pallet 20 or the workpiece on the pallet. In a preferred configuration, the printing head 30 in the relative retracted position does not occlude the projection path P. The laser marker 100 typically includes at least one scanning mirror, wherein laser parameters, such as output power and repetition rate, are set by a laser controller 104 and a central processing unit (CPU) 106. The parameters for the desired pattern to be made on the workpiece 8 are typically programmed into the CPU 106. The beam position and laser intensity can be rapidly modulated to produce the desired fading effects including, but not limited to, stone wash abrasion, graphic and text effects, photodecomposition, as well as perforating or cutting.

The CPU 106 has graphic information and formatted instructions to drive the galvanometric or scanning mirrors and control the laser parameters to produce the desired pattern on the textile material. As per the command sequence, a modulated or continuous laser beam originates from a laser oscillator 120. The laser oscillator 120 can be a CO₂, laser Nd:YAG laser, harmonics of an Nd:YAG laser, fiber laser, laser diode, or other laser source, q-switched with an acousto-optic or electro-optic modulator.

A Nd:YAG laser with a wavelength of around 1064 nanometers and a CO₂ laser with a wavelength of approximately 10600 nm can be employed. The laser beam can be generated by a frequency doubled or tripled Nd:YAG laser having a wavelength of approximately 532 nm or 354 nm, respectively.

Other possible wavelengths for other laser sources range between 190 nanometers to 10600 nanometers. An excimer laser can operate effectively at wavelengths 196 nm to 235 nm, or a CO₂ laser can operate effectively at 10600 nanometers. The wavelength of the laser can be chosen such that it is strongly absorbed by the dye to be faded but not by the textile material. The range of pulse duration used has been from 5 nanoseconds to 1000 milliseconds, with the best results being from 20 microseconds to 50 milliseconds. Other variables, such as the pulse energy, peak power, scan speed, dot pitch, and energy density, play an important factor in the degree of photo-decomposition and, depending upon the desired result, the avoidance of damage to the workpiece.

For example, these variable parameters can include the laser beam having a repetition rate from 1 hertz to 500 MHz (500×10⁶ hertz), a pulse duration between approximately 10 fs (10×10⁻¹⁵ seconds) to 500 ms (500×10⁻³ seconds). In addition, ranges from 5 nanoseconds to continuous are possible, in that the laser can have a continuous output beam and is classified as a CW laser, or the laser can have a scan speed of 1 mm per minute to 500 meter/second, and a dot pitch between 0.1 μm to 5 meters. A preferred range for the pulses is from 20 microseconds to approximately 1 millisecond.

It is understood alternative constructions can be employed. A laser of any type, including but not limited to a gas laser and a solid-state laser in CW or pulsed operation mode, produces a laser beam. A CO₂ laser may be preferred for processing many materials.

The laser beam can follow an optical system (not shown for clarity) that directs the beam onto an x-axis mirror 112 controlled by an x-axis galvanometer 122 and a y-axis mirror 114 controlled by an y-axis galvanometer 124. The beam is reflected from the x-axis mirror 112, which controls beam movement in the x-axis, onto the y-axis mirror 114, which controls beam movements in the y-axis. Preferably, the laser impinges the workpiece on the pallet 20 along a scanning pattern. The scanning pattern, or trace, can be created by any of a variety of scanning mechanisms. The particular scanning pattern, or trace, can be any of a variety of patterns including raster or vector.

The laser beam propagates through a focusing lens 130 and onto the workpiece. The focusing lens 130 can be located before or after the x and y scanning mirrors 112, 114. As the x-axis and y-axis mirrors 112, 114 are moved, the focused laser beam moves across the workpiece as directed by the CPU 106. The focusing lens 130 causes the laser beam passing through the lens to focus to a focal point along the optical axis. Preferably, the focusing lens 130 is selected to locate the focal point adjacent the workpiece or the pallet 20. However, it is understood the focal point can be moved along the optical path to selectively control the energy input to the workpiece and hence the amount of fading, or other selected laser treatment.

A moveable stage (not shown) can be used to hold the lens 30 so that the distance between the lens and the pallet 20 can be changed to alter the beam spot size as well as the focal point along the projection path. Alternatively, the pallet 20 can be moved relative to the lens 130.

While the laser marker 100 has been described in terms of a controller 104 and CPU 106, it is understood an integrated control system for both the laser marker 100 and the printing head 30 can be employed to coordinate and control printing by the printing head and application of the laser beam. Depending upon the particular model or manufacturer of the laser components, the laser controller and CPU can be integrated into a single unit, without impacting the scope of the invention.

Usually, the laser beam is directed generally perpendicular to the surface of the pallet 20, but it may be desirable to guide the beam to the surface with an angle to achieve certain effects. For example, the incident angle can range between about 45° and about 135°. That is, the path of the laser can be from 70° from a normal to the pallet 20 to substantially normal to the pallet.

Multiple laser scanning passes can be performed in treating a selected section of the workpiece 8. In general, any beam scanning scheme can be in the invention. For example, a commonly used line scanning scheme can be used to scan a surface in a line-by-line manner with each scanning line being a substantially straight line. Non-straight scanning lines can also be used to achieve certain surface appearance that may not be possible with straight scanning lines. In particular, scanning in non-straight lines can be used to enhance the feathering effect on the workpiece. The beam steering and scanning device and/or the focusing optics can be controlled with the control computer so that the trace of the scanning beam on a surface forms a certain waveform pattern. A sine or cosine type scanning line can be formed. Two adjacent wobbling lines may or may not overlap with each other. The wobbling scanning lines can be used in the scaling technique to compensate for the increased scanning spacing due to the increase in the size of an area to be processed.

The laser marker 100 can be regulated to substantially preclude degrading the workpiece 8 to the extent normally occurring in a physical abrasion area, while treating the workpiece to produce a fade pattern that mimics the physical abrasion pattern. Thus, the laser marker 100 can create localized “abrasions” in the workpiece 8, wherein the transition from the unfaded material to the fade of the abrasion in the material can be controlled in a manner to replicate an abrasion.

It has been found that use of the CO₂ laser on dyed cotton threaded textiles can cause a vaporization or ablation of the dye without significantly damaging the threads. That is, the laser energy impacted on the workpiece is greater than the vaporization/ablation threshold level of the dye in the cotton threads but is less than the vaporization/ablation threshold level for the cotton threads. Conversely, use of the Nd:YAG laser tends to photo-decompose or photo-bleach the dye in the cotton threads.

An alternative method for laser marking includes selectively altering the location of the focal point relative to the sheet material. Generally, the laser beam is brought out of focus at the areas where transitional fading is desired. More particularly, this is referred to as Z-axis focus control.

Z-axis focus control is a configuration available on some commercially available laser marking systems. A moveable, computer programmed, focusing system can be programmed to vary the focus across the scan field. The focusing system is programmed to defocus the beam as the beam nears the edges of the graphic being marked.

In one configuration, an occluding plate is selectively located in projection path P, upon disposing the printing head 30 (or at least the screen 34) in the printing position. The occluding plate is constructed to restrict or preclude intersection of the laser beam along the projection path P and the pallet 20. In an alternative configuration, power to the laser marker 100 can be interrupted upon disposing the printing head 30 (or the screen 34) in the printing position.

Conversely, when the printing head 30 (or the screen) is in the retracted position, the occluding plate is spaced from the projection path P, or power is supplied to the laser marker 100. Although it is not required to limit travel of the laser beam when the printing head 30 (or screen) is in the printing position, it is believed to enhance operator friendliness, by limiting the travel of the laser beam.

The present marking apparatus 10 provides for the application of a marking substance, such as ink or paint, to the workpiece and the laser treatment of the workpiece 8, without relocating (or re-registering) the workpiece relative to a pallet 20. Upon the workpiece 8 being registered with the pallet 20, multiple colors can be screened on the workpiece along with laser treatment, without requiring re-registration of the workpiece or optical sensors for identifying a location of the workpiece.

It is contemplated the printing, such as screen printing, and the laser treatment, such as laser marking, can be done in any order or combination. For example, the workpiece 8 can be screen printed and then laser treated, wherein the laser treatment is used to alter or set the ink, or is used to modify proportions of the garment that do not include ink.

Alternatively, the workpiece 8 can be initially laser treated, then the pallet moved to the relative printing position with respect to the printing head, and the workpiece printed.

As the screen 34 and/or the printing head 30 can be sized to overly a substantial portion of the workpiece on the pallet 20, it is understood the printing head may be sufficiently small to allow simultaneous printing, such as screen printing and laser marking of the workpiece. In this instance, the interlocks for precluding laser propagation along the projection path while the screen 34 and printing head 30 are in the print position would be deactivated.

Thus, the marking apparatus 10 provides increased throughput of the workpieces as re-registration between printing, such as screen printing and laser treatment, such as laser marking is obviated. Further, the marking apparatus 10 allows for sequential laser marking and screen printing, wherein the separate areas of the workpiece are treated. It is also understood, the laser treatment can be used to “pre-treat” sections of the workpiece 8 for the subsequent application of ink through the screen printing. Alternatively, the laser can be used to post-treat a screen printed workpiece, such as by cure, color, or altering previously applied ink, without re-registering the workpiece relative to the pallet 20.

Referring to FIG. 5, an alternative construction of the marking apparatus 10 is shown. In this configuration, the pallets 20 rotate relative to the screens 34. The pallets thus travel along an orbit or path. The laser marker 100 is disposed to intersect the path of the pallets 20. In one configuration, the laser marker 100 is stationary and the pallets rotate into operable alignment as the pallets rotate about the indexing table 22.

Referring to FIGS. 6 and 7, the present apparatus 10 can be configured to employ overhead printing heads 30. In this construction, typically the squeegee and flood bar and exposure of the ink to the screen 34 are disposed overhead, wherein the screen 34 and the pallet 20 are brought vertically into alignment with the printing head 30. In these configurations, the screen 34 is typically moved vertically between operable alignment with the printing head 30 and a spaced position. The pallets 20 rotate relative to the printing heads 30.

In FIG. 6, the laser marker 100 is disposed to be in the rotational path of the pallets 20. Thus, as the pallets 20 rotate between respective printing heads 30 (screens 34), the workpiece 8 can be operably aligned with the laser marker 100. In this construction, the laser marker 100 can be readily positioned relative to the apparatus 10 so as to be removeable.

In FIG. 7, the laser marker 100 is effectively connected to a printing head 30. Although any of a variety of mechanisms can be used to operably align the projection path of the laser marker 100 with the pallet 20 (and hence workpiece 8 on the pallet), a representative construction is shown in FIG. 7. A portion of the laser marker 100 is offset from the relevant printing head 30 such that as the pallet 20 approaches operable alignment with the corresponding printing head 30 (screen 34), the pallet and the workpiece intersect the projection path of the laser marker.

It is also understood that an optical guidance system such as mirrors or even fiber optics can be employed to intersect a workpiece 8 registered on the pallet 20 with the laser from the laser marker 100.

Therefore, the present apparatus provides for the laser treatment and application of ink (either through screen printing, impact printing or other inking applications) to a workpiece 8 under a single registration or alignment of the workpiece 8 relative to a pallet 20.

It has also been discovered that the laser can be used to form a plurality or multiplicity of micro perforations in the workpiece 8. The micro perforations can be on the order of the spot size of the laser. For example, perforations on the order of 10 mu (microns) to approximately 500 mu can be formed throughout or in selected portions of the workpiece, such as a garment. The perforations can be employed for either a decorative or functional result. For example, in the functional result, the micro perforations would allow the fabric to pass more air (breath), thereby providing a cooler garment for the user. Alternatively, the micro perforations can be used for purely design or aesthetic functions.

For synthetic fabrics, it has been found these micro perforations substantially retain their original size. That is, the fibers of the fabric are typically melted upon formation of the micro perforation, and the melted material anchors or locks the fibers about the periphery of the perforation to substantially preclude enlargement of the perforation. In contrast, for natural fibers such as cotton, wool or fiber mixes including natural fibers, the fibers do not melt; and thus there is a tendency of the fibers at the periphery of the micro perforation to fray or unwind. As the local fibers fray, the micro perforation is enlarged. It has been found that forming micro perforations on natural fibers in conjunction with an oil based ink (paint) on the fabric allows the micro perforations to substantially retain their original size through repeated use of the fabric. It is believed such an oil base ink (paint) effectively binds the fibers about the perimeter of the micro perforation, thereby reducing or even precluding the enlargement of the perforation.

An oil based paint (ink) that has been found satisfactory is a plastisol based ink. Plastisol inks can be used in the textile printing industry. These inks are easy to use, are very opaque on dark fabrics, and will adhere to most fabrics and give years of service, even through repeated washings. A true plastisol ink has no solvent and is made from 100% solid products. There is a plasticizer liquid in the ink which has a very high boiling point of 500 to 600° F. The major portion of the liquid part of the ink is plasticizer and polyvinyl chloride resins (PVC). These two ingredients determine the characteristics of the ink. Plastisol inks must be heated to dry. Plastisol inks can be printed on most textile surfaces as long as the material can withstand the temperatures of curing and as long as the ink can be absorbed or penetrated into the surface; so when the ink gels, it will adhere and form a permanent bond. When plastisol ink is heated, the PVC resin particles swell and absorb the liquid plasticizer; and these swelled particles merge with each other and form a solid film called an elastomer. Curing of plastisol ink is accomplished by rapidly bringing the ink up to curing temperature with electric, microwave, gas or infrared heaters which penetrate the ink quickly to insure a “fully cured” condition. The thicker the ink, the longer it will take to achieve this cured condition. A properly cured ink film will be able to stretch and then retract without cracking when pulled.

Although inks have been described, it is understood that a clear binder or adhesive type material can be applied to the natural fibers to effectively fix the fibers about the periphery of the perforation.

The present invention finds particular application to marking workpieces such as garments and particularly tops including, but not limited to, shirts, pullovers, sweatshirts, jackets and coats. However, it is understood the invention can be applied to treat bottoms including, but not limited to, shorts, briefs, slacks and pants.

While the invention has been described in connection with a presently preferred embodiment thereof, those skilled in the art will recognize that many modifications and changes can be made without departing from the true spirit and scope of the invention, which accordingly is intended to be defined solely by the appended claims.

1. An apparatus for treating a workpiece by printing and laser treatment, the apparatus comprising:
(a) a pallet for supporting at least a portion of the workpiece;
(b) a laser selectively projecting a laser beam along a projection path to intersect the pallet; and
(c) a printing head for printing the workpiece disposed on the pallet, the pallet being moveable relative to at least one of the laser and the printing head.

2. The apparatus of claim 1, further comprising a controller connected to the laser.

3. The apparatus of claim 1, wherein the printing head is moveable between a screening position and a retracted position.

4. The apparatus of claim 1, wherein the pallet includes a registration of the workpiece relative to the pallet for both the laser and the printing head.

5. The apparatus of claim 1, wherein the pallet is moveable.

6. The apparatus of claim 1, wherein the laser is fixed.

7. The apparatus of claim 1, wherein the laser is moveable.

8. The apparatus of claim 1, wherein the printing head includes a screen for passing the ink.

9. The apparatus of claim 1, wherein the laser includes a scanning laser.

10. A screen printing and laser treating apparatus for printing and laser treating a workpiece, the apparatus, comprising:
(a) a pallet for supporting at least a portion of the workpiece;
(b) a screen for passing ink to print on the workpiece, the pallet being moveable relative to the screen moveable between a screening position and a spaced position; and
(c) a laser projecting a laser beam along a projection path to intersect the pallet.

11. The screen printing and laser treating apparatus of claim 10, wherein the laser beam intersects the pallet in the spaced position.

12. The screen printing and laser treating apparatus of claim 10, further comprising a plurality of screens.

13. The screen printing and laser treating apparatus of claim 10, wherein the laser includes a focusing optic in the projection path for changing a focal point of the laser beam along the projection path.

14. The screen printing and laser treating apparatus of claim 10, wherein the laser includes a beam expander in the projection path.

15. The screen printing and laser treating apparatus of claim 10, wherein the laser includes a polygon scanner.

16. The screen printing and laser treating apparatus of claim 10, wherein the laser includes a galvanometer laser scanner.

17. The screen printing and laser treating apparatus of claim 10, wherein the laser is selected to cut the workpiece.

18. The screen printing and laser treating apparatus of claim 10, wherein the pallets rotate about a central axis.

19. The screen printing and laser treating apparatus of claim 10, further comprising a frame and a plurality of printing heads connected to the frame.

20. A method of marking a workpiece, the method comprising:
(a) registering the workpiece relative to a pallet;
(b) treating the workpiece with a laser;
(c) marking the workpiece with ink; and
(d) removing the laser treated and ink marked workpiece from the pallet.

21. The method of claim 20, wherein treating the workpiece with a laser includes at least one of fading, photo-decomposing, cutting, ablating, perforating or marking.

22. The method of claim 20, wherein marking the workpiece with ink includes passing the ink through a screen to mark the workpiece.

23. The method of claim 20, further comprising moving the pallet relative to a laser marker.

24. The method of claim 20, further comprising marking the workpiece with a plurality of inks.

25. A processed fabric, comprising:
(a) a fabric formed of natural fibers;
(b) a plurality of laser formed perforations in the fabric, each perforation having a periphery; and
(c) a binding coating on the fabric adjacent the periphery, the binding coating reducing a fray or unwinding of the fibers along the periphery.

26. The fabric of claim 25, wherein the binding coating is an oil base.

27. The fabric of claim 25, wherein the binding coating is a plastisol ink.

28. The fabric of claim 25, wherein the perforations have a diameter less than 500 microns.

29. The fabric of claim 25, wherein the perforations have a diameter less than 10 microns.

30. The fabric of claim 25, wherein the perforations have a diameter less than 1 millimeter.

31. An apparatus for marking a workpiece, comprising:
a plurality of printing heads;
a plurality of pallets moveable relative to the pallets, each pallet moveable between a printing position and a non-printing position; and
a laser projecting a laser beam along a projection path to intersect the pallet, upon the pallet being in the non-printing position.

32. The apparatus of claim 31, wherein each printing head includes a screen and a wiper for selectively urging ink through a screen.

33. The apparatus of claim 31, wherein the laser scanner is a galvanometer laser scanner.

34. The apparatus of claim 31, wherein the laser scanner is a polygon scanner.

35. A method of treating a fabric, comprising:
(a) laser forming a plurality of perforations in the fabric; and
(b) applying an oil based ink to the fabric.

36. The method of claim 35, wherein the laser forming occurs before applying the oil based ink.

37. The method of claim 35, wherein the laser forming occurs after applying the oil based ink.

38. The method of claim 35, further comprising precluding fraying of fibers with the ink adjacent the perforations.
